(19) United States
(12) Patent Application Publication
(10) Pub. No.: US 2002/0088555 A1
(43) Pub. Date: Jul. 11, 2002

(54) Laminate press machine

(76) Inventor: Shoji Urano, Aichi-ken (JP)

Correspondence Address: BROWDY AND NEIMARK, P.L.L.C., 624 NINTH STREET, NW, SUITE 300, WASHINGTON, DC, 20001-5303, US

(21) Appl. No.: 09/804,305

(22) Filed: Mar. 13, 2001

(30) Foreign Application Priority Data
Jan. 5, 2001 (JP) 2001-701

(51) Int. Cl. B30B 1/00

(52) U.S. Cl. 156/581; 156/580

(57) ABSTRACT

A structure of a laminate press machine for hoisting up a movable board with lifts located above an upper board is proposed, wherein the movable board (and pressure plates) can be hoisted in a well-balanced parallel position while at the same time obviating the inconveniences which otherwise might be caused in the various parts at the time of hoisting. In a press machine so configured that a movable board is hoisted by lifts located above an upper board to press each workpiece L between pressure plates, guide bars are vertically erected in the neighborhood of the four corners of said movable board and have guide surfaces in a plane where said movable board is not rotated about the center of the flat surface where the lines from the neighborhood of the four corner positions cross each other, the guide surfaces extending from the neighborhood of the four corner positions in the direction along the crossing lines. The movable board has slide guide portions adapted to slide in close contact with the guide surfaces of the guide bars.

### BACKGROUND OF THE INVENTION

1. Field of the Invention

This invention relates to a laminate press machine, or in particular to a laminate press machine for producing a laminate such as a printed wiring board.

2. Description of the Related Art

In recent years, a laminate press machine for producing a laminate of a printed wiring board has been used, which is so configured that a movable board and an upper board are arranged in a chamber, a plurality of pressure plates each with a workpiece mounted thereon are arranged between said movable board and said upper board, and said movable board is hoisted up by lifts located above said upper board thereby to press each of said workpieces intermediate of said pressure plates between said movable board and said upper board.

A laminate press machine of this type in which the movable board is pushed up by a ram has conventionally been used widely. In the press machine of ram push-up type, however, pressure plates in multiple stages, if any, (say, 15 stages or more) rise to a height of about several meters. In such a case, to adjust a height of the peripheral units such as a conveyor, the lower ram cylinder portion is required to be embedded in a pit dug in the floor, resulting in costly work and equipment. This also makes it difficult to change the layout and gives rise to the problem that both addition and relocation are difficult.

With the press machine of a type in which the movable board is hoisted up by lifts located above the upper board described above, in contrast, the height corresponding to the ram for pushing up the movable board is saved in the lower portion of the machine. Therefore, no pit is required to be dug even in the case where the pressure plates are in multiple stages, thereby reducing the cost correspondingly. In addition, the layout change, addition and relocation are facilitated. This press machine in which the movable board is hoisted up is called the “pitless” type and is going to find wide applications. Nevertheless, the following operating problems have been pointed out for the press machine of this type.

First, it is not an easy matter to hoist up, in a well-balanced horizontal parallel position, the movable board (and the pressure plates) having a comparatively large flat surface with a side length of 1000 to 1500 mm by means of a plurality of lifts normally arranged, for example, at the four corners of the upper board. Especially in the case where the hydraulic cylinder is used as the lift, it is very difficult to supply the same amount of the pressure oil to each cylinder unit at the same time and thereby to hoist up the movable board (and the pressure plates) in a well-balanced horizontal parallel position.

Secondly, when hoisting up the movable board with the lifts at the four corners, the outer peripheral sides of the movable board where the lift rods of the lift are mounted develop a slight displacement due to the bending moment. This displacement developed on the outer peripheral sides of the movable board causes the bending of the lift rods mounted there, which in turn causes the operating inconveniences such as bite and friction derived from the unbalanced load (one-sided contact) or the like at the sliding contact portion of the lift rods. Especially in the case where a hydraulic cylinder is used as a lift, an unbalanced load (one-sided contact) is imparted to the cylinder packing in sliding contact with the piston rods for activating the lift rods. In such a case, oil is often liable to leak from the packings loosely mounted for avoiding the operating inconveniences such as bite and friction due to the unbalanced load (one-sided contact).

Thirdly, when hoisting up the movable board with the lifts arranged above the upper board, the outer peripheral sides of the upper board is subjected to a load and develop a slight displacement. In the case where the hydraulic cylinder unit is used as a lift, an unbalanced load (one-sided contact) is imposed on the cylinder packing in sliding contact with the piston rods of the cylinder unit, thereby posing a similar problem to the one described above.

### SUMMARY OF THE INVENTION

In view of the problem points described above, this invention proposes a structure of a laminate press machine of what is called pitless type, wherein, to assure more efficient and effective use, the movable board (and the pressure plates) can be hoisted up by the lifts arranged above the movable board in a well-balanced parallel horizontal position and the inconveniences which otherwise might be developed at the various parts at the time of hoist up can be obviated.

Specifically, according to claim 1 of the invention, there is provided, in a press machine comprising a movable board and an upper board arranged in a chamber, and configured in such a manner that a plurality of pressure plates each with a workpiece mounted thereon are arranged between said movable board and said upper board, and said movable board is hoisted up by lifts arranged above said upper board thereby to press each of said workpieces on said pressure plates between said movable board and said upper board, a laminate press machine characterized in that guide bars each having a guide surface are erected vertically in the neighborhood of the four corners of the movable board, respectively, said guide surfaces extending, in a plane where the movable board is not rotated about the center of the flat surface of the movable board, from said neighborhood of the four corners of the movable board along the direction of lines crossing at the center of the flat surface of the movable board, said movable board having slide guide portions adapted to slide in close contact with the guide surfaces of the guide bars.

Also, the invention according to claim 2 relates to the laminate press machine of claim 1 in which the guide surfaces of said guide bars are configured of an oilless metal plate.

According to claim 3 of the invention, there is provided, in a press machine comprising a movable board and an upper board arranged in a chamber and configured in such a manner that a plurality of pressure plates each with a workpiece mounted thereon are arranged between said movable board and said upper board, and said movable board is hoisted up by lifts arranged above said upper board thereby to press each of said workpieces on said pressure plates between said movable board and said upper board, a laminate press machine characterized in that guide bars each having a guide surface are erected vertically in the neighborhood of the four corners of the pressure plates, respectively, said guide surfaces extending, in a plane where the pressure plates are not rotated about the center of the flat surface of the pressure plates, from said neighborhood of the four corners of the pressure plates along the direction of lines crossing at the center of the flat surface of the pressure plates, said pressure plates each having slide guide portions adapted to slide in close contact with the guide surfaces of the guide bars.

The invention according to claim 4 relates to the laminate press machine of claim 3, wherein said guide bars double as the guide bars of the movable board described in claim 1 or 2.

According to claim 5 of the invention, there is provided, in a press machine comprising a movable board and an upper board arranged in a chamber and configured in such a manner that a plurality of pressure plates each with a workpiece mounted thereon are arranged between said movable board and said upper board and said movable board is hoisted up by lifts arranged above said upper board thereby to press each of said workpieces on said pressure plates between said movable board and said upper board, a laminate press machine characterized in that the lift rods of said lifts are each coupled to said movable board through a horizontal axial member adapted to rotate said movable board with respect to said lift rods.

According to claim 6 of the invention, there is provided, in a press machine comprising a movable board and an upper board arranged in a chamber and configured in such a manner that a plurality of pressure plates each with a workpiece mounted thereon are arranged between said movable board and said upper board and said movable board is hoisted up by lifts arranged above said upper board thereby to press each of said workpieces on said pressure plates between said movable board and said upper board, a laminate press machine characterized in that said lifts are configured of a plurality of cylinder units arranged above said upper board, and the cylinder bodies of said cylinder units are each arranged inclinably with respect to said upper board.

### BRIEF DESCRIPTION OF THE DRAWINGS

FIG. 1 is a partly cutaway front view schematically showing the whole of a laminate press machine according to an embodiment of the invention.

FIG. 2 is a sectional view taken in line 2-2 of FIG. 1 schematically showing the flat surface of the movable board.

FIG. 3 is a partial enlarged sectional view of FIG. 2.

FIG. 4 is a sectional view taken in line 4-4 of FIG. 1 schematically showing the flat surface of the pressure plate.

FIG. 5 is a partial enlarged view of FIG. 4.

FIG. 6 is a partial enlarged front view showing the manner in which the slide guide portion of the movable board is mounted.

FIG. 7 is a partial enlarged front view showing the manner in which the slide guide portion of the pressure plate is mounted.

FIG. 8 is a partly cutaway sectional view, as taken from the front, showing the portion of the lift rod coupled to the movable board.

FIG. 9 is a partly cutaway sectional view of another coupling structure of the lift rods as taken from the front.

FIG. 10 is a side view of the coupled portion of FIG. 9.

FIG. 11 is a schematic model diagram for explaining the bending moment imposed on the movable board when the lift rods are operated.

FIG. 12 is a schematic model diagram for explaining the bending moment imposed on the upper board when the lift rods are operated.

### DESCRIPTION OF THE PREFERRED EMBODIMENT

This invention will be described in detail below with reference to the accompanying drawings.

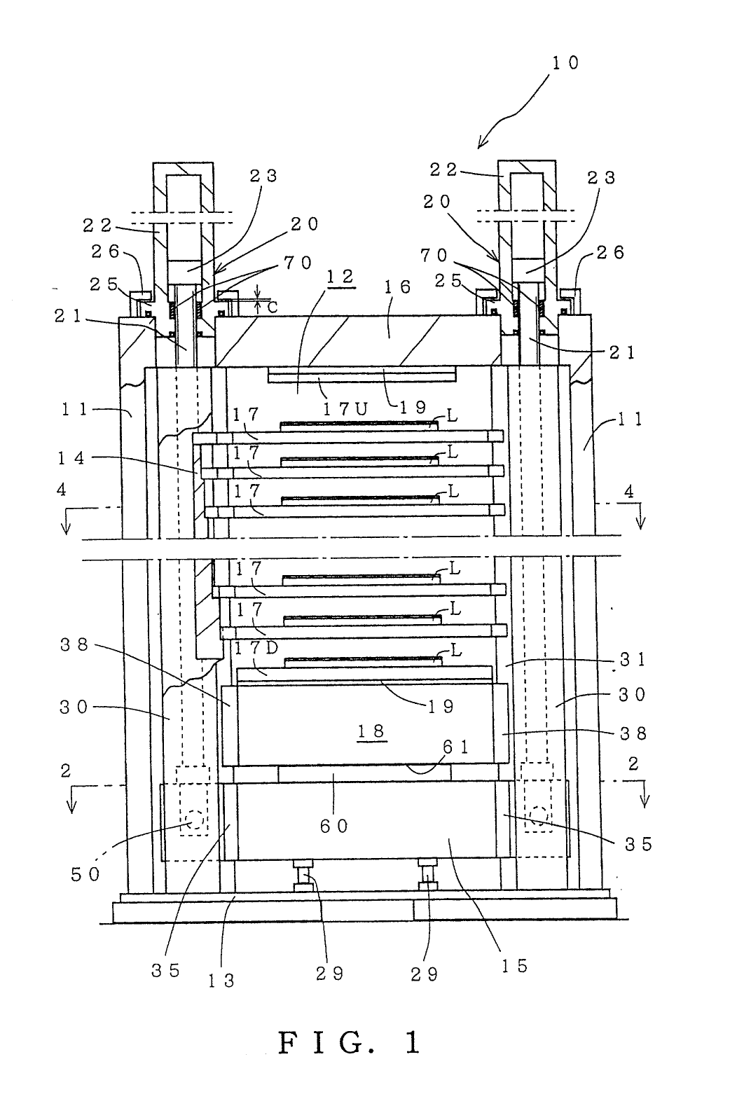

The laminate press machine 10 shown in FIG. 1 is called a laminate press machine of the pitless type, as described above. This press machine is configured with a movable board 15 and an upper board 16 in a chamber 12, and a plurality of pressure plates 17, 17 arranged between the movable board 15 and the upper board 16 and having workpieces mounted thereon, wherein the movable board 15 is hoisted up by lifts (cylinder units) 20, 20 above the upper board 16 so that each of the workpieces L, L arranged between the pressure plates 17, 17 are pressed between the movable board 15 and the upper board 16. The chamber 12 may contain a vacuum, and the pressure plates 17 may be thermal pressure plates.

In the drawing, reference numeral 11 designates machine supports, numeral 13 a machine base, numeral 14 a stepped plate (frame) for setting the pressure plates 17 in predetermined step positions, numeral 17U an upper fixing pressure plate, numeral 17D a lower fixing pressure plate, numeral 18 a lower board, numeral 19 an insulating member, numeral 21 lift rods (piston rods for the cylinder units) of the lifts 20, and numeral 29 jack bolts for determining the lower limit position of the movable board 15.

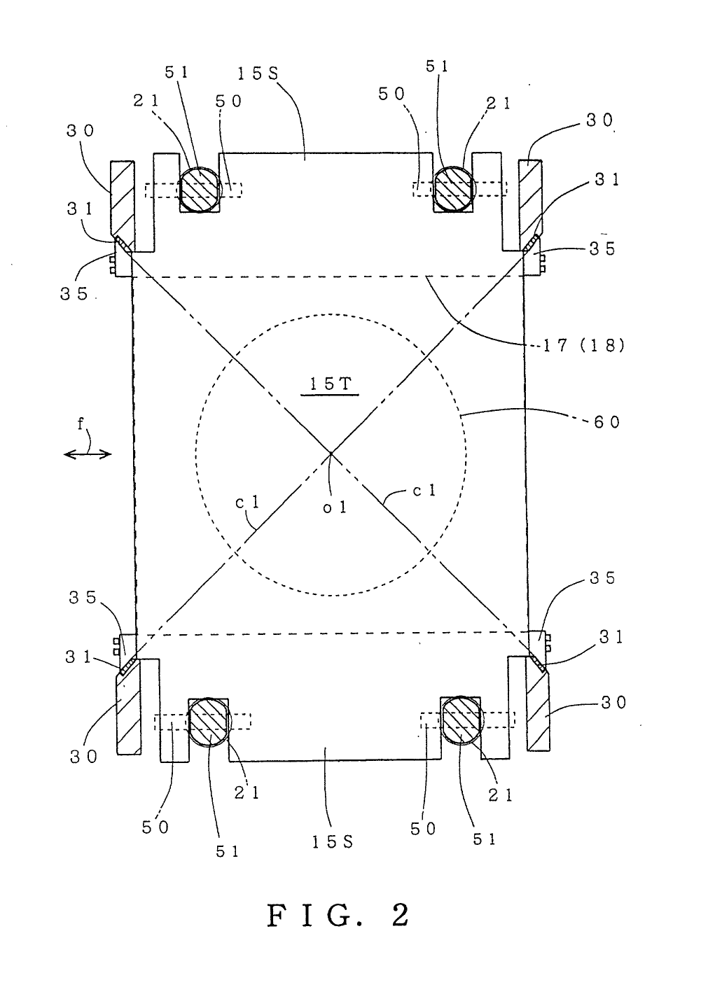

Numeral 60 is a central pressure member defined in claim 9, which as shown by dashed line in FIG. 2, which is arranged at the upper central portion above the movable board 15 in such a way as to press the substantially central portion of the pressure plates 17. This central pressure member 60 is for correcting the displacement of the center 15T of the movable board 15 caused when pressing the workpieces L by hoisting up the outer peripheral portions 15S of the movable board 15 with the lifts 20, 20. As a result, the pressure imparted on the workpieces L is equalized. Any central pressure member 60 having this function will do and can have a quality and a thickness not specifically defined. By the way, a board member (lower board) 18 as shown is preferably arranged on the pressure-imparting surface 61 side of the central pressure member 60. In FIG. 1, the central pressure member 60, the lower board 18, the insulating member 19 therefor and the lowest-stage pressure plate 17D are secured integrally with the movable board 15.

Now, the invention according to claim 1 will be explained. As will be well understood from FIG. 2, in the laminate press machine 10 according to this invention, guide bars 30, 30 are erected vertically in the neighborhood of the four corners of the movable board 15 and have guide surfaces 31 extending from the neighborhood of the four corners of the movable board 15 along the direction of lines c1, c1 crossing at the center o1 of the flat surface of the movable board 15, the guide surfaces 31 being contained in a plane where the movable board 15 is not rotated about the center o1 of the flat surface of the movable board as an axis, the movable board 15 having slide guides 35, 35 in close sliding contact with the guide surfaces 31 of the guide bars 30, 30. The symbol f designates the front side by way of which the workpieces L are loaded and unloaded.

As seen from FIG. 2, the guide surfaces 31 of the four guide bars 30 arranged in the neighborhood of the four corners of the movable board 15 are formed in opposed relation to each other vertically at the right and right portions in the drawing. Thus, the movable board 15 is prevented by the slide guide members 35 corresponding to the guide surfaces 31 from being rotated about the flat surface center o1 as an axis in the direction along the plane thereof. By the way, as long as one (one set) of the guide surfaces 31 of the four guide bars 30 are arranged in opposed relation to each other, the movable board 15 can be prevented from rotating in the direction along the plane thereof. As a result, the movable board 15 can be moved vertically without any displacement in the direction along the plane thereof.

Also, according to this invention, the guide surfaces 31 of the guide bars 30 are each formed as a surface extending in the direction along the lines cl crossing the flat surface center o1 of the movable board 15. Consequently, the thermal expansion or contraction, if any is developed, by the movable board 15 in the direction along the plane can be absorbed.

The guide bars 30 each having the guide surface 31 are erected in vertical direction, and the movable board 15 includes the slide guide portions 35, 35 adapted to slide in close contact with the guide surfaces 31 of the guide bars 30. The slide guide bar portions 35 are made of a metal block member or the like, and as shown in FIG. 1, are preferably formed over the entire thickness of the movable board 15.

The lower board 18, which is arranged according to the embodiment shown in FIG. 1 as described above, is preferably provided with slide guide portions 38, 38 adapted to slide in close contact with the guide surfaces 31 of the guide bars 30.

According to the invention of claim 1 configured as described above, the whole movable board 15 can be moved vertically maintaining a well-balanced horizontal position without developing any rotational displacement along the flat surface thereof. Also, the thermal expansion or contraction which may be developed in the movable board 15 can be absorbed.

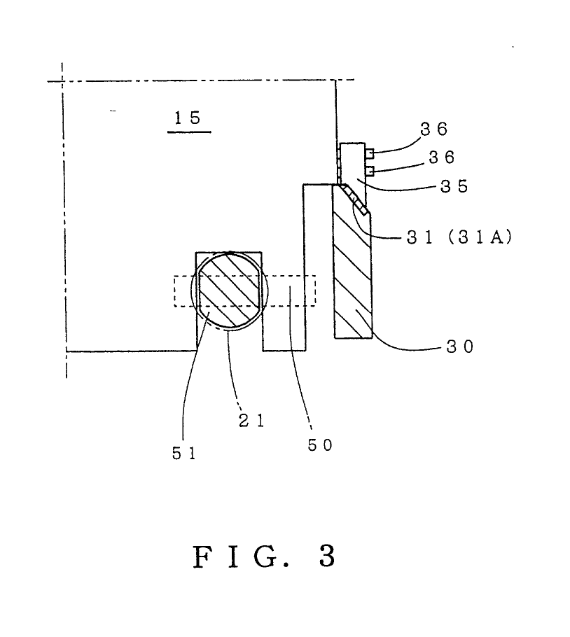

According to the invention of claim 2, the guide surfaces 31 of the guide bars 30 are configured of an oilless metal plate 31A. As shown in FIG. 3, by forming the guide surfaces 31 of the oilless metal plate 31A in this way, the slide guide portions 35 of the movable board 15 smoothly slide, thereby making possible smooth and accurate operation of the movable board 15. By the way, the oilless metal plate 31A is widely available on the market and is, for example, type “SO-50SP2” from Sankyo Oilless Industry.

The invention according to claim 3 relates to a structure of said machine for hoisting up the pressure plates 17 in horizontal parallel position. By the way, this structure is desirably used with the structure according to claim 1 in which the movable board 15 is hoisted up in horizontal position.

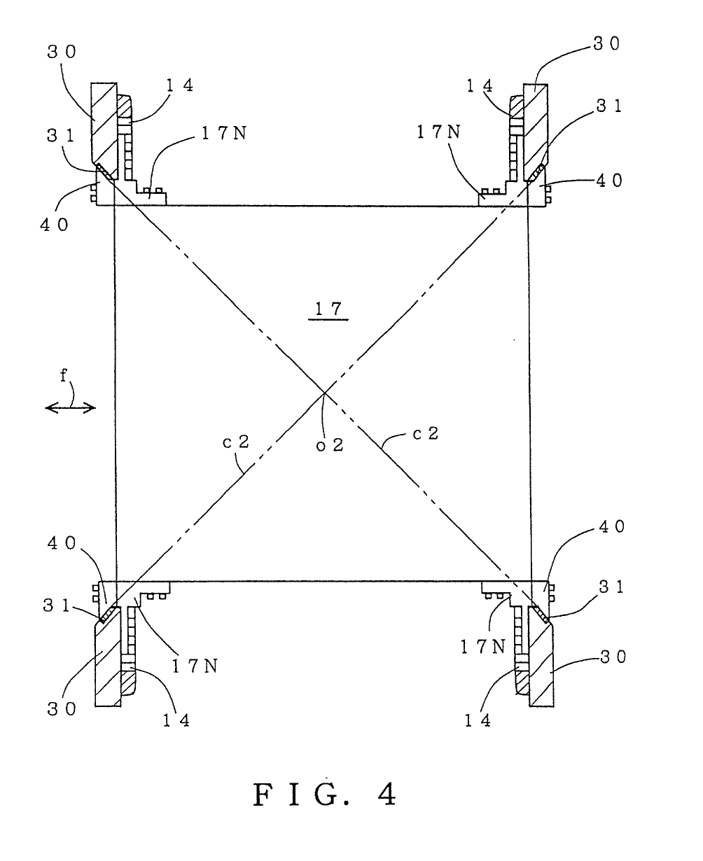

This invention according to claim 3 has a similar configuration to the invention according to claim 1 described above. Specifically, this invention is characterized in that, as shown in FIG. 4, guide bars 30 are erected vertically in the neighborhood of the four corners of the pressure plates 17, 17 and have guide surfaces 31 extending from the neighborhood of the four corners of the pressure plates 17, 17 along the direction of lines c2, c2 crossing at the center o2 of the flat surface of the pressure plates 17, the guide surfaces 31 being contained in a plane where the pressure plates 17 are not rotated about the center o2 of the flat surface of the pressure plates 17 as an axis, the pressure plates 17 having slide guide portions 40 in close sliding contact with the guide surfaces 31 of the guide bars 30, 30.

In the shown embodiment, as defined in the invention according to claim 4, the guide bars 30 (and the guide surfaces 31 thereof) double as those used for the movable board 15 described above. As described above, the guide bars 30, if provided for the movable board 15, are desirably shared for saving equipment on the one hand and for efficient, positive vertical movement of the movable board 15 and the pressure plates 17 on the other.

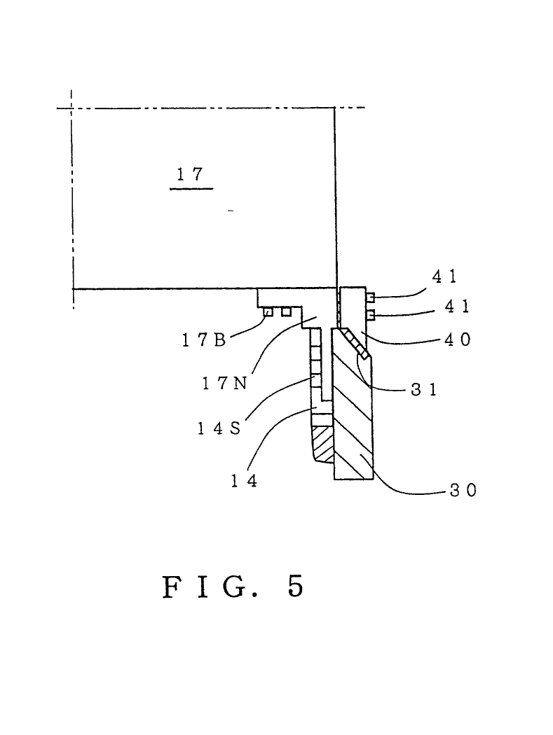

As shown in FIG. 4 and FIG. 5 which is a partial enlarged view of FIG. 4, the guide surfaces 31 of the four guide bars 30 arranged in the neighborhood of the four corner positions of the pressure plates 17 are formed in vertically opposed relation to each other at the left and right portions in the drawing, and for the same reason as described earlier for the movable board 15, the pressure plates 17 are not rotated about the flat surface center o2 of the pressure plate as an axis. Thus, each pressure plate 17 can be moved vertically without displacement which otherwise might be caused by the rotation in the horizontal plane thereof.

Also, as described with reference to the movable board 15, a thermal expansion or contraction, even if developed in the pressure plates 17, can be absorbed by the guide surfaces 31 of the guide bars 30 each of which is formed as a surface extending in the direction along the crossing lines c2 crossing at the flat surface center o2 of the pressure plate 17.

The guide bars 30 having the guide surfaces 31 are erected vertically, and each pressure plate 17 is provided with a slide guide portion 40 adapted to be in close sliding contact with the guide surfaces 31 of the guide bars 30. The slide guide portion 40 is made of a metal block member or the like, and arranged over the whole thickness of the pressure plate 17 as shown in FIG. 1. By the way, the slide guide portion 40 in this case, as shown in FIGS. 4 and 5, is mounted on a hook member 17N of the pressure plate 17 for setting the pressure plate 17 on the stepped plate 14. In FIG. 5, numeral 14S designates a stepped portion of the stepped plate 14, and numeral 17B mounting bolts.

According to the invention of claim 3 configured as described above, the whole of the pressure plates 17 can be moved vertically in well-balanced horizontal parallel positions. Further, the displacement of the pressure plates 17 in horizontal direction by rotation is prevented, and the thermal expansion or contraction, if developed in the pressure plates 17, can be effectively absorbed.

In an embodiment the height of the slide guide portions 35 or 40 can be adjusted with respect to the guide surfaces 31 of the guide bars 30.

For example, as shown in the partial enlarged view of FIG. 6, the slide guide member 35 mounted on the movable board 15 has four height adjusting set screws 46, 36 at four positions including upper, lower, left and right positions, thereby making it possible to adjust the sliding height of the slide guide members 35 with respect to the guide surfaces 31 of the guide bars 30. As a result, the angle of the sliding surface of the slide guide member 35 can be adjusted, and therefore more accurate vertical movement along the guide bars 30 of the movable board 15 is made possible. Reference numeral 37 designates mounting bolts for fixing.

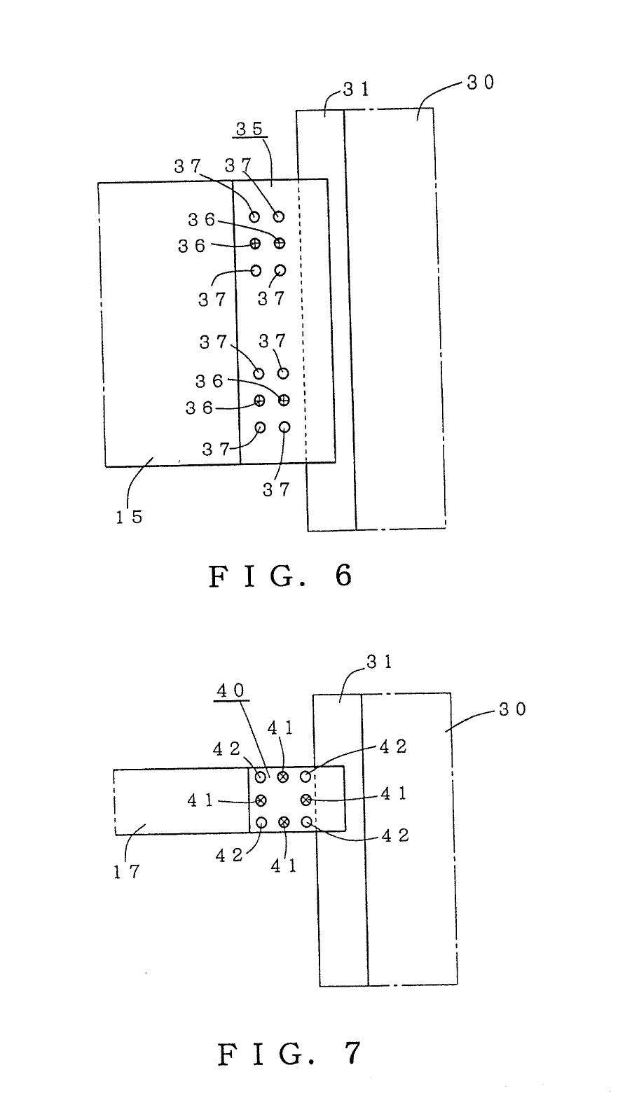

This is also the case with the pressure plates 17. FIG. 7 is a partial enlarged view of the portion associated with the pressure plate 17 shown in FIG. 1. The slide guide member 40 mounted on the pressure plate 17 is also provided with four height adjusting set screws 41, 41 at upper, lower, left and right positions for adjusting the sliding height of the slide guide member 40 with respect to the guide surfaces 31 of the guide bars 30. As a result, the angle of the sliding surface of the slide guide member 40 can be adjusted, and therefore more accurate vertical movement of the pressure plates 17 along the guide bars 30 is made possible. Reference numeral 42 designates mounting bolts for fixing.

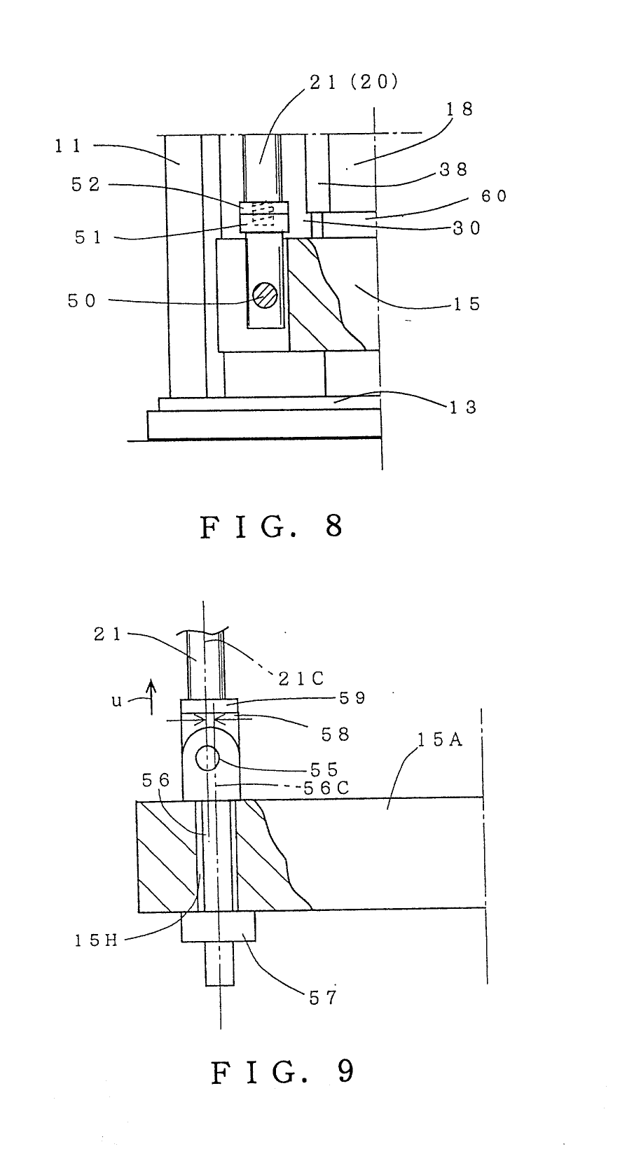

Now, the invention according to claim 5 will be explained. The invention according to claim 5, which concerns the press machine described above, is characterized in that, as shown in the partial sectional view of FIG. 8, the lift rods 21 of the lifts 20 are each coupled to the movable board 15 through a horizontal axial member 50 whereby the movable board 15 is rotatable with respect to the lift rods 21. In FIG. 8, numeral 51 designates a coupling member between the lift rod 21 and the horizontal axial member 50, and numeral 52 a lock nut.

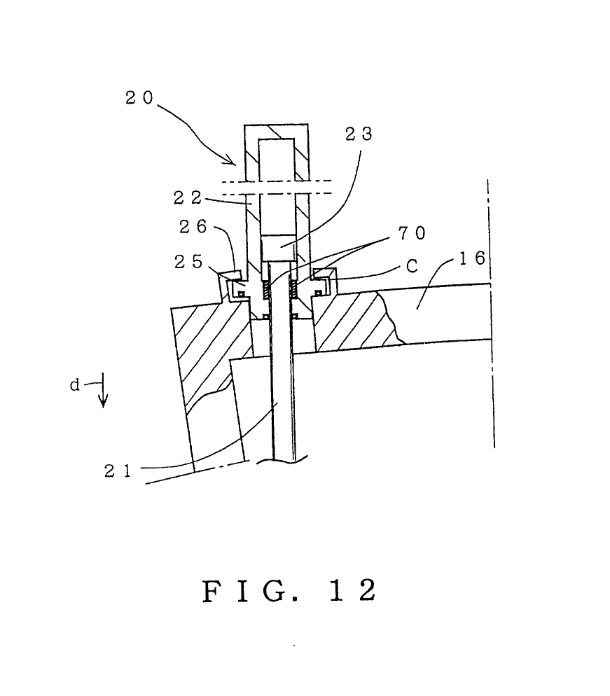

As described above and shown in FIG. 11, when the lift rods 21 hoist the movable board 15 upward in the direction u, the bending moment is generated between the outer peripheral side 15S of the movable board 15 with the lift rod 21 mounted thereon and the inner side 15N thereof, so that the movable board 15 is slightly displaced. Though exaggerated in the drawing to facilitate explanation, the displacement is actually about several hundredths of one mm. This displacement of the movable board 15, as described above, causes the bend of the lift rods 21 and the operating inconveniences such as bite and friction. In the case where a hydraulic cylinder unit is used as a lift, an unbalanced load (one-sided contact) is imposed on the cylinder packing in sliding contact with the piston rod providing the lift rod. It was described that loosing the packing for avoiding this inconvenience causes an oil leakage.

In view of this, according to the invention of claim 5, the lift rods 21 of the lifts 20 are each coupled to the movable board 15 through a horizontal axial member 50 whereby the movable board 15 is rotatable with respect to the lift rods 21. As a result, even when the outer peripheral portions of the movable board 15 are displaced by the bending moment under load, the lift rods 21 are not bent in view of the fact that the lift rods 21 mounted on the movable board 15 through the horizontal axial member 50 are rotated with respect to the movable board 15. Thus, the operating inconveniences are eliminated which otherwise might be caused in the sliding contact portion of the lift rods 21, or especially, the sliding contact portion between the piston rod providing the lift rod 21 and the cylinder packing 70 in the case where the hydraulic cylinder unit is used. At the same time, the oil leakage caused by the operating inconveniences can be prevented. By the way, numeral 21P with a chain line in FIG. 11 designates the lift rod which has developed a bend due to the conventional structure.

Also, as shown in FIG. 11, the provision of the horizontal axial member 50 at the center along the thickness of the movable board 15 totally prevents the change of the interval between the lift rods 21 even if the movable board 15 is displaced. The chain in FIG. 11 designates the center along the thickness of the movable board 15.

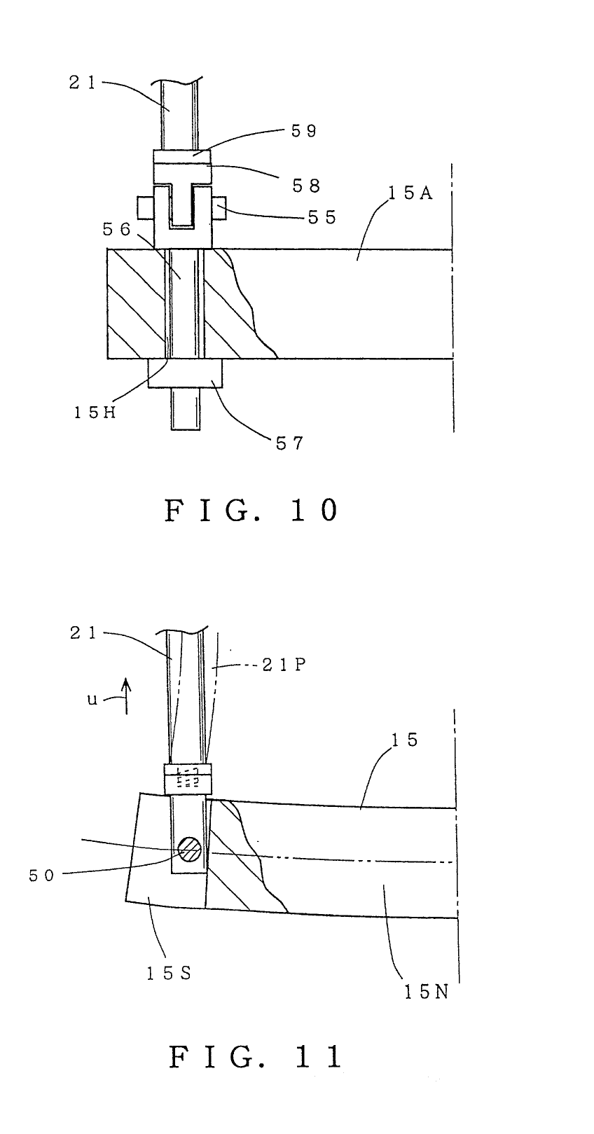

The embodiments shown in FIGS. 1 and 8 are an example in which the horizontal axial member 50 is arranged at the central position along the thickness of the movable board 15, and the axial member 50 is coupled directly to the lift rod 21 by the coupling member 51. As an alternative to this example, as shown in FIGS. 9 and 10, a connecting rod 56 may be formed through a mounting hole 15H of the movable board 15A and coupled with the end portion 58 of the lift rod 21 by means of the horizontal axial member 55. In the drawing, reference numeral 57 designates a fixing nut for the connecting rod, and numeral 59 a lock nut. In this case, as shown in FIG. 9, in order to eliminate the effect of the displacement of the movable board 15A on the shortening of the interval between the lift rods 21, it is recommended that the axial center 21C of the lift rod 21 is slightly (0.1 to 0.2 mm) displaced outside from the axial center 56C of the connecting rod 56 so that the original interval between each pair of the lift rods 21 can be maintained when the movable board 15A is displaced. By doing so, the connecting rod 56 of the movable board 15A moves inward under load, and therefore the effect on the lift rod 21 can be eliminated.

The invention according to claim 6, on the other hand, is to solve a similar problem for the upper board 16, and as shown in FIGS. 1 and 12, is characterized in that the lifts 20 include a plurality of cylinder units arranged above the upper board 16 and the cylinder body 22 of each of the lifts 20 is installed inclinably with respect to the upper board 16.

Specifically, as shown in FIG. 12, a partial enlarged view for explaining the lift 20 of FIG. 1, when the piston rods 21 providing the lift rods hoist up the movable board 15, as in the case of the movable board 15 described above, a bending moment in the downward direction d is generated on the outer peripheral sides of the upper board 16 having the cylinder unit 20 providing a lift mounted thereon, thereby displacing the upper board 16. By the way, although the drawing is exaggerated for facilitating explanation, the displacement is actually several hundredths of one mm. This displacement of the upper board 16 causes an unbalanced load on the piston rods 21 of the cylinder units 20 providing the lifts, which in turn is a cause of the one-sided contact or bite of the packing 70 in the sliding contact portion of the piston rod 21, thereby causing the same operating inconvenience as that described above.

In view of this, the invention according to claim 6 is intended, as shown in FIG. 12, to alleviate the unbalanced load on the piston rods 21 by arranging the cylinder body 22 of the cylinder unit 20 inclinably with respect to the upper board 16. Reference numeral 23 designates a piston. According to this embodiment, an example is shown in which a clamp member 26 is installed through a clearance C (see FIG. 1) on a flange 25 of the cylinder body 22. This clearance C is about 0.1 mm. The piston rod 21 is moved downward by the weight of the movable board 15 itself, and the only function required of the clamp member 26 is to prevent the rise of the cylinder body 22. Thus, the cylinder body 22 may be arranged on the upper board 16 inclinably without the clamp member 26.

With this invention according to claim 6, in which the cylinder body 22 of the cylinder unit 20 arranged above the upper board 16 is installed inclinably with respect to the upper board 16, the displacement of the outer peripheral sides of the upper board 16, if caused by the bending moment, can be absorbed by the inclination of the cylinder body 22 and thereby the unbalanced load is prevented from being imposed on the piston rod 21, thereby eliminating the operating inconveniences such as the bite and oil leakage of the cylinder packing 70.

The provision of the central pressure member 60 shown in FIG. 1 in association with any one of the preceding claims can equalize the pressure on the workpieces and further improve the effects of the laminate press machine according to this invention.

As illustrated and described above, according to this invention, there is provided a laminate press machine of pitless type in which the movable board (and the pressure plates) are hoisted by the lifts located above the upper board in a well-balanced horizontal position, while at the same time eliminating the inconveniences which otherwise might be caused in the various parts at the time of hoist-up, thus making it possible to use the machine efficiently and effectively.

What is claimed is:

1. In a press machine comprising a movable board and an upper board arranged in a chamber, and configured in such a manner that a plurality of pressure plates each with a workpiece mounted thereon are arranged between said movable board and said upper board, and said movable board is hoisted up by lifts arranged above said upper board thereby to press each of said workpieces on said pressure plates between said movable board and said upper board,
a laminate press machine characterized in that guide bars each having a guide surface are erected vertically in the neighborhood of the four corners of the movable board, respectively, said guide surfaces extending, in a plane where the movable board is not rotated about the center of the flat surface of the movable board, from said neighborhood of the four corners of the movable board along the direction of lines crossing at the center of the flat surface of the movable board, said movable board having slide guide portions adapted to slide in close contact with the guide surfaces of the guide bars.

2. A laminate press machine according to claim 1, wherein the guide surfaces of said guide bars are configured of an oilless metal plate.

3. In a press machine comprising a movable board and an upper board arranged in a chamber, and configured in such a manner that a plurality of pressure plates each with a workpiece mounted thereon are arranged between said movable board and said upper board, and said movable board is hoisted up by lifts arranged above said upper board -thereby to press each of said workpieces on said pressure plates between said movable board and said upper board,
a laminate press machine characterized in that guide bars each having a guide surface are erected vertically in the neighborhood of the four corners of the pressure plates, respectively, said guide surfaces extending, in a plane where the pressure plates are not rotated about the center of the flat surface of the pressure plates, from said neighborhood of the four corners of the pressure plates along the direction of lines crossing at the center of the flat surface of the pressure plates, said pressure plates each having slide guide portions adapted to slide in close contact with the guide surfaces of the guide bars.

4. A laminate press machine according to claim 3, wherein said guide bars double as the guide bars of the movable board described in claim 1.

5. In a press machine comprising a movable board and an upper board arranged in a chamber, and configured in such a manner that a plurality of pressure plates each with a workpiece mounted thereon are arranged between said movable board and said upper board, and said movable board is hoisted up by lifts arranged above said upper board thereby to press each of said workpieces on said pressure plates between said movable board and said upper board,
a laminate press machine characterized in that the lift rods of said lifts are each coupled to said movable board through a horizontal axial member adapted to rotate said movable board with respect to said lift rods.

6. In a press machine comprising a movable board and an upper board arranged in a chamber, and configured in such a manner that a plurality of pressure plates each with a workpiece mounted thereon are arranged between said movable board and said upper board, and said movable board is hoisted up by lifts arranged above said upper board thereby to press each of said workpieces on said pressure plates between said movable board and said upper board,
a laminate press machine characterized in that said lifts are configured of a plurality of cylinder units arranged above said upper board, and the cylinder bodies of said cylinder units are each arranged inclinably with respect to said upper board.
